(19) United States
(12) Patent Application Publication
(10) Pub. No.: US 2002/0009696 A1
(43) Pub. Date: Jan. 24, 2002

(54) Method and apparatus for communicating emotions and needs

(76) Inventors: Barbara J. Lui, Seattle, WA (US); David M. Brubakken, Seattle, WA (US)

Correspondence Address: Frederick A. Kaseburg, Garrison & Associates PS, Suite 3300, 2001 Sixth Avenue, Seattle, WA, 98121-2522, US

(21) Appl. No.: 09/771,476

(22) Filed: Jan. 26, 2001

Related U.S. Application Data
(63) Continuation-in-part of application No. 09/418,687, filed on Oct. 14, 1999, now abandoned.

(51) Int. Cl. G09B 1/36; G09B 19/00

(52) U.S. Cl. 434/171; 434/112; 434/236

(57) ABSTRACT

An educational method, apparatus, and instructions for improving an individual's ability to identify and express emotions, associate their emotion with needs, and then communicate the emotion and need through blocks having multiple faces. The apparatus comprises at least two sets of blocks and a support structure. A first set of blocks has faces bearing informative indicia identifying various emotions or feelings. A second set of blocks has faces bearing informative indicia which identify various needs. The support structure comprises optional textual material. The method and instructions lead the individual through the process of linking feelings identified through the use of the first set of blocks with needs identified through use of the second set, establishing an association between emotions and needs, and providing a simple verbal framework for identifying, linking, and sharing or describing feelings and needs. The invention can be practiced on a computer.

### CROSS REFERENCE TO RELATED APPLICATION

This application is a continuation-in-part of and claims priority based on application Ser. No. 09/418,687 filed Oct. 14, 1999.

### TECHNICAL FIELD

An educational method and apparatus for improving an individual's ability to identify and express their emotions, associate their emotion with needs related to the emotion, and then communicate the emotion and need. The method and apparatus facilitate communicable association between emotions and needs, emotional self-awareness, and self control, through the use of multiple physical, or virtual, blocks having multiple faces suggesting emotions and needs.

### BACKGROUND OF THE INVENTION

It is well known both within and without the medical and mental health fields that a major obstacle to communication between people is a lack of emotional self-awareness and of an adequate vocabulary on the part of such individuals to permit the efficient or effective exchange of feelings or needs. Many books, pamphlets, and other descriptive or instructional materials have been produced, and uncountable hours of classroom training and individual and group counseling have been expended, in efforts to educate those who would be benefitted by an improvement in their emotional self-awareness and communication skills. Yet neither the reading of printed matter, formal training, nor passive or semi-passive counseling have proven wholly satisfactory. At some point the parties to a relationship, or the person struggling for self expression, must actually take the step of communication. There has been a long-felt need for effective methods and devices to aid in this process.

Several attempts at both aiding individuals with the identification of emotions of needs have been made, but so far no one has offered a satisfactory solution to the larger problem of both identifying and communicating both the emotion felt and the resultant need.

For example, U.S. Pat. No. 5,580,254 to Ramsey discloses a communication aid consisting of a plurality of color coded cards, each color-coded card corresponding to a mood of a user, placed in a display device as a way to communicate to others an emotion felt by the user. No provision is made, however, for identifying associated needs or for communication of such needs, or thereby the completion of a full statement of the problem felt by a user. Moreover, identification of the user's emotion by others is dependent upon use of a separate reference to interpret the code. Thus, instead of encouraging the voicing of feelings and needs, the Ramsey devices encourages and facilitates the user's avoiding putting feelings into words.

U.S. Pat. No. 5,040,988 to Brown discloses method and apparatus for a visual mood and cause indicator. The Brown devices includes a display board for use with a variety of flags and pegs for identifying various user moods and causes for the moods. Like Ramsey, however, the Brown devices makes no provision for identifying associated resultant needs or for communication of such needs, or for the completion of a full verbal statement of the problem felt by a user and a suitable possibility for resolution, and requires a separate code reference for others to interpret the user's emotional statement. Again, the disclosed device actually works to encourage the user not to voice feelings or needs.

U.S. Pat. No. 4,173,833, Rosenblatt discloses a psychological game which includes a base with a plurality of recesses and spheres of varying colors which match the recesses having blanks for answers, the combination of answers and colors having a revelatory nature in combination with the disclosed procedures. No provision is made for offering the user a range of suggestions for various emotional possibilities, or for completing causal statements of emotions and needs, and direct statement of needs and feelings is avoided; information is collected indirectly through the story telling process, and interpreted by a monitor or counselor.

U.S. Pat. No. 3,779,557, to Kritzberg et al. discloses a psychological testing board and game having a set of emotionally significant words arranged to be completed by adding lettered pieces as a prelude to storytelling, meant to incite emotional recreation based on word stimuli, the idea being to gain insight to the psychology of the user by having the user complete stories indirectly reflecting their emotional and mental state. Particular emotions and resultant needs are not addressed, and expression of needs and emotions is accomplished only indirectly.

U.S. Pat. No. 5,741,137 to Aduvala discloses cards and three dimensional blocks adapted for helping children name emotions and to describe the intensity with which they feel them. Aduvala does not, however, disclose means for identifying or communicating associated needs, or exploring links between them.

Thus, there is a need for an educational method and apparatus for improving an individual's ability to identify and express their emotions, associate the emotion with the individual's needs related to the emotion, and then communicate the emotion and the need. There is further a need for a system which permits the efficient and reliable identification of emotions and needs associated therewith, as an aid to encouraging correct and direct communication and satisfaction of human needs.

### DISCLOSURE OF THE INVENTION

Accordingly, it is an object of the invention to provide a system for improving an individual's ability to identify and express their emotions, associate the emotion with the individual's needs related to the emotion, and then communicate the emotion and need.

A second object of the invention is to provide a system that permits the efficient and reliable identification of felt emotions and needs associated therewith, as an aid to encouraging correct and direct communication and satisfaction of human needs.

Another object of the invention is to facilitate communicable association between emotions and needs, emotional self-awareness, and self control, through the use of multiple physical, or virtual, blocks having multiple faces suggesting emotions and needs.

An additional object of the invention is to provide a system that can be implemented with a computer, where the computer includes both the method and the apparatus.

The preceding objects of the invention are achieved in accordance with the following features of the present invention. The present invention provides an educational method that includes instructions and an apparatus. The inventors have devised new means and method for facilitating direct communication and emotional awareness. The invention educates a user, or several users, both in recognizing and expressing thoughts or emotions. Use of the invention involves an individual user, the apparatus, and the educational instructions, and optionally a facilitator who can be a teacher or therapist.

The apparatus of the invention provides a plurality of physical or virtual blocks. The blocks can be solid or hollow, and made of any substance suitable for the intended use and that is capable of being symbol and/or color coded, either directly or by application of another material to the block. Each block comprises a plurality of labeled faces. In a first set of said blocks, said faces comprise labels and/or images identifying a range or variety of emotions or other feelings which might be felt by the user. In a second set of said blocks, the faces comprise labels and/or images identifying a variety of needs which might be felt by the user.

The Instructions of the Invention involve the user selecting one or more blocks from the first set, and identifying their emotion or feeling state on one of the labeled faces. The user then places that block on a surface with the selected face up. The user then selects one or more blocks from the second set, and identifies one of the labeled faces as their appropriate need related to the previously selected emotion or feeling. The user then places that block on a surface with the selected face up. By their actions, the user has associated an emotion with a need. The user may optionally communicate the emotion, the need, and the association, to others.

Through the use of the instructions and the plurality of blocks, the invention educates and improves an individual's ability to identify and express their emotions, associate the emotion with the individual's needs related to the emotion, and then communicate the emotion and need through the use.

The following provides more detail concerning the invention. The apparatus for teaching and communicating emotions and needs according to the invention comprises a plurality of blocks. Each of the blocks has a plurality of faces, each face bearing a related image and/or label. In a first set of said blocks, each of the faces comprise a label and/or images identifying a range or variety of emotions or other feelings which might be felt by the user. In a second set of said blocks, each of the faces comprise a label and/or images identifying a variety of needs which might be felt by the user. A user may, by holding at least of one block from the first set in his or her hand and turning said block, review said variety of emotions. Similarly, by holding at least one of said blocks from the second set in his or her hand and turning the block, the user may review the expressed variety of needs. By placing the blocks on a surface or in the support structure in a selected orientation and juxtaposition, the user may identify a communicable association between at least one of said emotions and one of said needs, and thereby be assisted in communicating the associated emotion and need.

An important aspect of the invention is the use of blocks for identifying emotions and needs possibly felt by the user. It has been found that many users find the use of labeled and/or image-bearing blocks preferable to the use of cards, flags, pins, and other devices. Reasons cited by users for this preference include the greater physical pleasure of manipulating a pleasingly hefty block of some pleasant-feeling substance such as wood or plastic, as opposed to the relative flatness and lack of substance possessed by pasteboard cards, and the pleasant sensation of manipulating the blocks to view the various faces and their associated text or images. Blocks may be of any geometrical shape, from tetrahedrons to quadrahedrons or any other multifaceted solids. Generally preferred embodiments of the invention comprise cubic blocks, particularly when intended for use by children. This due at least partly to the familiar, generally pleasing shape of the cube and the relative familiarity of children with cubic blocks, as well as the ease with which cubic blocks are adapted to work with recessed trays for displaying any selected side of the block.

Images provided on block faces, or on the support structure described below, may comprise textual or pictorial material, or both. A wide range of emotions, needs, and associations may be presented. For example, a physical apparatus according to the invention might include informative indicia on faces of blocks such as “mean”, “angry”, “happy”, “sad”, “frustrated”, “calm”, “anxious”, etc., in a first set for feelings; and such as “hugs”, “talking”, “exercise”, “music”, etc., in the second set for needs. However, the apparatus could easily be adapted to facilitate education and communication with respect to any cause-effect or feeling-action type associations. The invention is not limited to the linking of feelings and needs. Variations in color and additional textual and pictorial material may be useful as well, as will be understood by psychologists, psychiatrists, counselors, and others familiar with emotions and needs, and problems in the communication thereof, in human beings. Variations in color are used in alternative embodiments of the blocks and the support structure to aid the user to distinguish between the first and second sets of blocks, the right and left locations in the support structure, the feeling gauge, and other aspects of the invention.

An alternative embodiment of the apparatus includes a support structure adapted to hold the blocks in the selected orientation and juxtaposition. Optional additional information printed on the support structure provides textual material adapted to guide the user through the process of associating feelings identified through the use of the first set of blocks with needs identified through use of the second set, and providing the user with a verbal framework for direct communication of his or her feelings and needs. In preferred embodiments of this aspect of the invention the support structure also comprises images. These images are adapted for use in assisting the identification of the communicable association between the emotion and need felt by the user. For example, the support structure may be labeled with the legend “I feel” before the location designated for placement of an emotion-identifying block from the first set, and “I need” before the location designated for the placement of a need-identifying block from the second set. Thus by appropriate selection and disposition of blocks a statement such as “I feel mean, I need to walk” might be suggested through direct textual means. Alternatively, pictures or other graphic images might be employed, to provide any of a wide variety of functions in associating first- and second-set blocks.

A convenient and effective way of adapting the support structure according to this aspect of the invention to hold the blocks in a selectable orientation and juxtaposition is to provide the support structure with recesses adapted for reception of the blocks. Thus a preferred support structure according to the invention might provide a recess sized to receive a block from the first set and a second recess for reception of a block from the second set. In such an embodiment the recesses are easily disposed such that the blocks, when placed in the support structure, are next to each other such that both the emotion identified by the first-set block and the need identified by the second-set block are easily discernable, and so that the association between the emotion and the need is easily discerned as well.

A particularly useful optional use of images disposed on the support structure according to the invention is to provide additional suggestions and insights regarding a user's feelings and needs. For example, it has been found to be particularly useful to add a legend adapted to aid the user in identifying the intensity of his or her feelings or needs, termed a feeling gauge. Such a legend advantageously takes the form of a numerically graduated scale, as for example between zero and five, with a legend indicating that a level of zero corresponds to “not at all” and a level of five corresponds to a level of “very much”. By appropriate encouragement a user can be led to an identification of the intensity with which a particular feeling or need, once identified, is felt.

Teaching and communicating according to the invention also comprises the Instructions of the Invention. In the instructions, first the user removes all the blocks from any tray or container and places them on a horizontal surface. The user next selects one or more blocks from the first set by identifying which of the labeled faces suggesting a feeling or emotion best describes the user. The user then places that block or blocks on the surface, with the selected face up. In the alternative embodiment comprising a support structure, the user would place the block in the left-hand “I feel” slots of the support structure. Next, the user indicates on the feeling gauge the intensity of the feeling. Then, the user selects one or more blocks from the second set by identifying which of the labeled faces suggesting a need best describes what would help the user when the user feels the emotions or feelings identified in the block or blocks selected from the first set. The user then places that block or blocks on the surface, to the left side of the block or blocks from the first set, with the selected face up, so that an association between the feeling and the need may be identified and optionally communicated. In the alternative embodiment comprising a support structure, the user would place the block in the right-hand “I need” slots of the support structure. The user then communicates and expresses their selection of blocks to the facilitator. Thus the user is aided in recognizing, filling, and expressing his or her feelings and needs.

The above summary of the instructions includes the alternative embodiment employing the support structure. If the embodiment with the support structure is not used, the portions of the above steps referring to support structure are not included in the instructions.

In another aspect the invention provides a virtual block and support structure system of the type defined. The virtual block and support structure system is produced through the generation of appropriate data fields by an electronic computer and the display of the block and support structure system on a computer display device such as a CRT or flat panel display. The blocks in virtual embodiments of the invention may be manipulated by any means associated with the control of computer processors and displays, such mouse-based point and click devices, keyboards, etc.

A particular advantage of embodiments of the invention comprising physical blocks and support structure is that the system may be placed physically between a group of two or more people, and manipulated as described by as many of the group as the group feels it may be advantageous to permit to participate, so that direct communication between members of the group may be facilitated. It has been found that face to face use of the invention, in close proximity between members of the group, greatly increases communication amongst the group, by reducing confrontation and increasing interaction among the group.

It has also been found to be advantageous to place the entire teaching apparatus in a box sized to receive the support structure securely, and deep enough to receive both the support structure and all blocks when they are in position within the support structure. It is found that the use of this configuration permits the convenient and safe storage and transportation of teaching apparatus according to the invention.

As will be apparent, the method involved in the invention may be practiced by a broad range of users, including those of various age, competence, skill, and abilities, to establish communication with other individuals, including peers, parents, teachers, therapists, and health care professionals. These and other objects of the present invention will become readily apparent upon further review of the following specifications and drawings.

### BRIEF DESCRIPTION OF THE DRAWINGS

For a fuller understanding of the nature of the present invention, reference should be had to the following detailed description taken in connection with the accompanying drawings in which:

FIG. 1 is a schematic perspective view of a preferred embodiment of an apparatus according to the invention.

FIG. 2 is a schematic perspective view of an alternative preferred embodiment of an apparatus according to the invention.

### BEST MODE OF CARRYING OUT THE INVENTION

As used herein, a block is any three-dimensional physical object, solid or otherwise, or any virtual representation thereof, having at least three faces of a size suitable for carrying an image of size suitable for use in the manner described herein.

As used herein, the words “feeling” and “emotion” are used individually, interchangeably, and collectively. Theses words both refer to the common definition of pleasurable or painful sensations experienced when a person is stirred to sympathy, anger, fear, hate, love, joy, grief, and the like.

As used herein, “informative indicia” means any textual material, pictorial representations, and image representing the subject matters that are to be associated by the user according to the invention. In this best mode, an example of informative indicia on the physical apparatus might include both text and images representative of feelings such as “mean”, “angry”, “happy”, “sad”, “frustrated”, “calm”, “anxious”, etc. on one set, and needs such as “hugs”, “talking”, “exercise”, “music”, etc., on the second set. For example, the words “calm” and an image of a serene looking person might appear on a single face of a block, the block being colored red with the text and image in black. However, the apparatus could easily be adapted to facilitate education and communication with respect to any cause-effect or feeling-action type associations. The invention is not limited to feelings and needs. References herein to “labels” are an alternative mode of expressing informative indicia.

As used herein, “support structure” means a structure comprising a display surface formed thereon which is structured and disposed to removably support and display a number of the blocks in a selectable orientation and juxtaposition. The support structure is sometimes referred to herein as a tray.

As used herein, “visible,” when used in conjunction with the block in the support structure, means orientating the block or blocks are suitably orientated to display the selected face for viewing the informative indica thereon.

As used herein, the invention includes Instructions of the Invention for improving an individual's ability to identify and express their emotions, associate the emotion with needs related to the emotion, and then communicate the emotion and need. The “Instructions of the Invention” are defined as follows: First, the user removes all the blocks from any support structure or container and places them on a horizontal surface. Next, the user selects one or more blocks from the first set by identifying which of the labeled faces suggesting a feeling or emotion best describes the user. Then, the user places that block or blocks on the surface, with the selected face up. In the alternative embodiment comprising a support structure, the user would place the block in the left-hand “I feel” slots of the support structure. Next, the user indicates on the feeling gauge the intensity of the feeling. Then, the user selects one or more blocks from the second set by identifying which of the labeled faces suggesting a need best describes what would help the user when the user feels the emotions or feelings identified in the block or blocks selected from the first set. Next, the user places that block or blocks on the surface, to the left side of the block or blocks from the first set, with the selected face up, so that an association between the feeling and the need may be identified and optionally communicated. In the alternative embodiment comprising a support structure, the user would place the block in the right-hand “I need” slots of the support structure. Next, the user communicates and expresses their selection of blocks to the facilitator. Thus the user is aided in recognizing, filling, and expressing his or her feelings and needs. The above definition of the instructions includes the alternative embodiment employing the support structure. If the embodiment with the support structure is not used, the portions of the above steps referring to support structure are not included in the instructions. When a facilitator is involved in the educational method, the facilitator may explain the Instructions of the Invention to the user. The facilitator, if appropriate, may lead the user through the invention and the instructions by example. The facilitator first demonstrates the instructions using feelings and needs of the facilitator, and then invites the user to follow the lead. The facilitator may assist the user in performing the invention by engaging the user in conversation designed to assist the user in forming and communicating the association between the identified emotions and needs.

As used herein, a facilitator can be any other person, including interested acquaintance, peers, parents, teachers, therapists, counselor, and health care professionals.

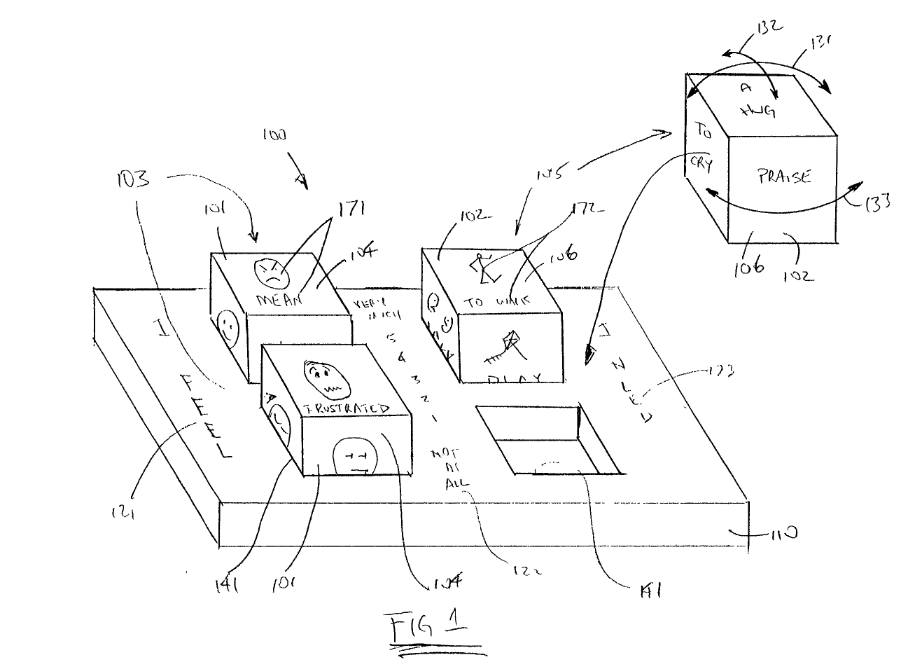

A preferred embodiment of the apparatus of the invention is shown in FIG. 1. The teaching apparatus 100 comprises blocks 101 and 102, which are shown in a generally preferred cubic embodiment, and support structure 110. Blocks 101 of first set 103 each comprise a plurality of faces 104 which bear images 171 identifying various emotions or feelings of a user (not shown). Blocks 102 of second set 105 comprise labeled faces 106 having images 172 which identify various or selected needs of a user. Support structure 110 comprises optional textual material 121, 122, and 123, which is adapted to guide the user through the method for linking feelings identified through the use of the first set of blocks with needs identified through use of the second set, establishing an association between said emotions and said needs, and providing the user a simple verbal framework for identifying, linking, and sharing or describing his or her feelings and needs. Support structure 110 further is adapted by means of recesses or seats 141 for blocks 101 and 102. Blocks 101 and 102 may be removed from recesses 141, manipulated by a user so that any desired face may be placed in a viewing position (generally, but not necessarily, upward), and replaced in its desired seat. By thus selecting a feeling for each of the blocks 101 of set 103 and a need for each of the blocks 102, an association may be established between particular combinations of feelings and needs and a suitable manner of communication for meeting the identified needs determined. Through the use of optional textual materials 121, 122, 123, and selectable orientations and juxtapositions of blocks by rotation of the blocks through any of the three rotational directions 131, 132, or 133, or placement in any of the plurality of seats 141, particular associations may be suggested or developed, and communication further encouraged. For example, as shown in FIG. 1, the textual material may be used to construct an expressive statement of the form, “I feel frustrated; I need a hug, very much”. As shown by textual material 122, the intensity or other qualities of either the feeling or the need or both may be amplified or determined and communication of his/her needs by the user further encouraged.

Optional textual material 122 on support structure 110 is adapted to aid a user in identifying the intensity of his or her feelings or needs. The legend is configured in the form of a numerically graduated scale ranging from zero to five, and includes a legend indicating that a level of zero corresponds to “not at all” and a level of five corresponds to a level of “very much”. The legend is sometimes referred to herein as the “feeling gauge.” By appropriate encouragement a user is led to an identification of the intensity with which a particular feeling or need, once identified, is felt. A user might, for example, indicate uncertainty as to how he or she feels about a given emotion or need. The facilitator explains the meaning of the graduated scale and asks the user how much he or she experiences a given feeling, as for example sadness. The user may then indicate a level on graduated scale to indicate how intensely or un-intensely he or she feels. The facilitator may then work through an entire range of emotions or feelings until a feeling with a rating of higher than zero is identified. Any needs associated with the feeling are then identified by working through images on faces of blocks from the second set, upon which the user finds that he or she has been provided with a solid framework for expressing the need, as a first step toward having it satisfied.

Intensity gauges or feeling gauges of the type described are particularly important in as much as they relate to the entire concept of self control and self-management of emotions. For example, they may be used to teach users that different feelings may be experienced in different degrees—a child, for example, might feel very angry (a rating, for example, of 5), moderately sad (a rating of 3), and not at all loving (a rating of 0). The user then might be asked, for example, what needs might be satisfied in order to bring his or her anger and sadness levels down while increasing the intensity of love feelings. This is especially useful in that many people are never taught self control through the realization that different feelings may be experienced simultaneously. For example, a child might feel extremely angry at someone at the same time that he or she feels happy for having struck that person in retaliation for a perceived wrong. Such a child might record intense feelings of both anger and happiness simultaneously. A challenge such as teaching the child to focus on non-violent, non-aggressive and socially appropriate choices from the second set need blocks might also result in an intense happiness feeling.

Alternative embodiments of the feeling gauge include placing the information on an additional block. Each faces of the block would include a representation of a degree of feeling or need.

The preferred embodiment shown in FIG. 1 comprises four cubic blocks, each of which provide six faces and convenient locations for at least six images or labels on each block. It is obvious that other shapes of blocks might be used, to provide more or fewer faces and spaces for labels. Labels or images may be permanently affixed by paint, decal, or stencil, or releasably attached by means of Velcro, low-strength durable glues, etc. Physical blocks and support structure are preferably made of wood, cardboard, plastic, or any other suitable material, and are of any suitably manipulable size. It has been found that wooden cubic blocks of about 2.5″ inches per side are very pleasant and convenient for handling by humans, and are especially attractive to children due to their size, weight, and the capacity of their faces for carrying pleasant and attractive images.

In FIG. 1, optional textual material 122 on support structure 110 is adapted to aid a user in identifying the intensity of his or her feelings or needs. The legend is configured in the form of a numerically graduated scale ranging from zero to five, and includes a legend indicating that a level of zero corresponds to “not at all” and a level of five corresponds to a level of “very much”. The legend is sometimes referred to herein as the “feeling gauge.” By appropriate encouragement a user is led to an identification of the intensity with which a particular feeling or need, once identified, is felt. A user might, for example, indicate uncertainty as to how he or she feels about a given emotion or need. The facilitator explains the meaning of the graduated scale and asks the user how much he or she experiences a given feeling, as for example sadness. The user may then indicate a level on graduated scale to indicate how intensely or un-intensely he or she feels. The facilitator may then work through an entire range of emotions or feelings until a feeling with a rating of higher than zero is identified. Any needs associated with the feeling are then identified by working through images on faces of blocks from the second set, upon which the user finds that he or she has been provided with a solid framework for expressing the need, as a first step toward having it satisfied.

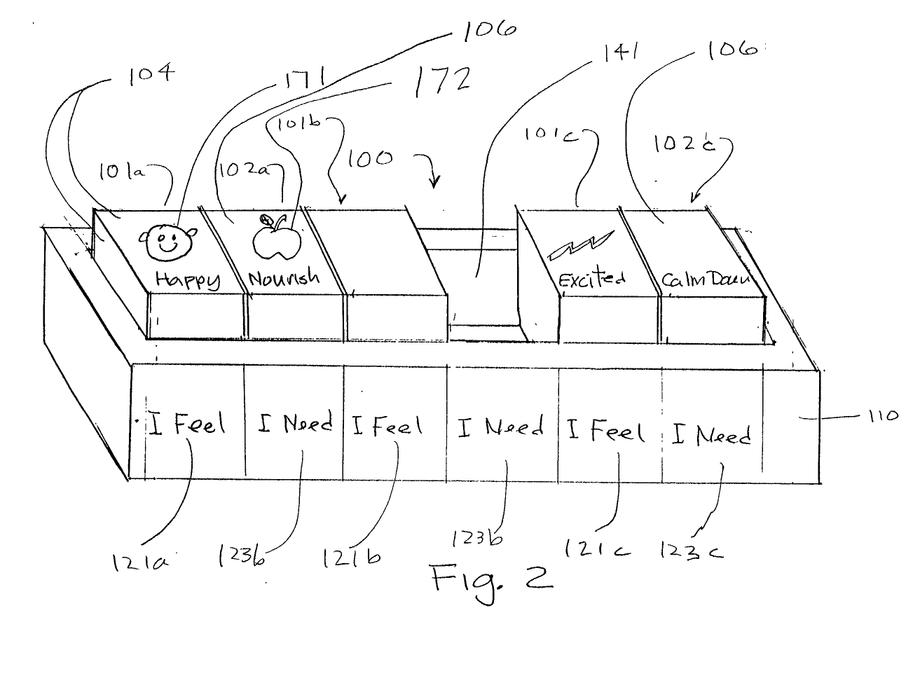

An alternative preferred embodiment of the apparatus of the invention is shown in FIG. 2. The teaching apparatus 100 comprises blocks 101a-c and 102a-c (102b is not shown), which are shown in a generally preferred cubic embodiment, and support structure 110. Blocks 101a-c of first set 103 each comprise a plurality of faces 104 which bear images 171 identifying various emotions or feelings of a user (not shown). Blocks 102a-c of second set 105 comprise labeled faces 106 having images 172 which identify various or selected needs of a user. Support structure 110 comprises optional textual material 121a-c, and 123a-c, which is adapted to guide the user through the method for linking feelings identified through the use of the first set of blocks with needs identified through use of the second set, establishing an association between said emotions and said needs, and providing the user a simple verbal framework for identifying, linking, and sharing or describing his or her feelings and needs. Support structure 110 further is adapted by means of recesses or seats 141 for blocks 101a-c and 102a-c. Blocks 101a-c and 102a-c may be removed from recesses 141, manipulated by a user so that any desired face may be placed in a viewing position (generally, but not necessarily, upward), and replaced in its desired recess. By thus selecting a feeling from one or more of the blocks 101a-c of set 103 and a need from one or more of the blocks 102a-c, an association may be established between particular combinations of feelings and needs and a suitable manner of communication for meeting the identified needs determined. Through the use of optional textual materials 121a-c, and 123a-c, and selectable orientations and juxtapositions of blocks by rotation of the blocks through any of the three rotational directions, or placement in any of the plurality of seats 141, particular associations may be suggested or developed, and communication further encouraged. As shown in FIG. 2, the textual material forms a communicating array that may be used to construct an expressive statement of the form, “I feel excited; I need to calm down.”

Virtual embodiments of the apparatus may be identical to the physical embodiment described, but embodied in a computer-generated image projected onto a computer display and electronically manipulated through the use of electronic mice, etc. As such, they may be displayed in precisely the manner shown in FIG. 1, as a flat image on a screen representing a perspective view of a physical embodiment of the invention, or in any other suitable or convenient format.

With regard to systems and components above referred to, but not otherwise specified or described in detail herein, the workings and specifications of such systems and components and the manner in which they may be made or assembled or used, both cooperatively with each other and with the other elements of the invention described herein to effect the purposes herein disclosed, are all believed to be well within the knowledge of those skilled in the art. No concerted attempt to repeat here what is generally known to the artisan has therefore been made.

### EXAMPLES

In a first example, an apparatus according to the invention as described above and depicted in FIG. 1 was constructed using two sets of two cubic blocks each, and a support structure having four recesses for supporting the blocks. The blocks are wooden measure 2.5 inches per side. The first set of blocks are red in color and carry images identifying the feelings or emotions “loving,” “mean,” “angry,” “scared,” “o.k.,” “silly,” “happy,” “excited,” “calm,” “sad,” and “lonely,” and carry simple depictions of human faces bearing suitable illustrative expressions. The second set of blocks are green and identify “exercise,” “a hug,” “to cry,” “praise,” “music,” “time alone,” “to breathe deeply,” “to talk,” “to sing,” “to walk,” “to play,” and “to rest” as needs which might arise from the feeling of these emotions; each of the needs is illustrated by a simple picture. The blocks are provided with a support structure having four recesses, each approximately 2.5 inches square and about 2″ deep. The support structure is colored attractively, and contains textual legends “I feel” in association with the first set of blocks and “I need” in association with the second set of blocks. In a central area the support structure bears the text “very much” and “not at all,” with a numbered scale between zero and five to aid the user in identifying the intensity of his or her feelings and needs. The Instructions of the Invention is printed on the support structure. The Instructions of the Invention is also printed on paper and placed in a box. The support structure and blocks are packaged in a convenient box, so that the apparatus may be kept together and transported with ease.

In a second example, an apparatus according to the invention as described above and depicted in FIG. 2 was constructed using two sets of three cubic blocks each, and a support structure having a single recess supporting the six blocks in adjacent alignment. The blocks are wooden measuring 1.75 inches per side. The first set of blocks are red in color and carry painted or silk-screened informative indicia for emotions similar to FIG. 1. The second set of blocks are green and carry informative indicia for needs similar to FIG. 1. The blocks are provided with a support structure having a single rectangular recess approximately 10.5 inches long, 1.8 inches wide, and 1 inch deep. The support structure is colored attractively, and contains textual legends “I feel” in association with the first set of blocks and “I need” in association with the second set of blocks. The textual legends alternate along the length of the support structure, indicating that the blocks are to be supported in an alternating manner. The Instructions of the Invention are printed on the support structure. The support structure and blocks are packaged in a convenient box, so that the entire apparatus may be kept together and transported with ease.

In compliance with the statute, the invention has been described in language more or less specific as to structural features and method. It is to be understood, however, that the invention is not limited to the specific features shown or instructions described, since the instructions and construction shown comprise preferred forms of putting the invention into effect. The invention is, therefore, claimed in any of its forms or modifications within the legitimate and valid scope of the appended claims, appropriately interpreted in accordance with the doctrine of equivalents.

### Industrial Applicability

An educational method and apparatus for improving an individual's ability to identify and express their emotions, associate their emotion with needs related to the emotion, and then communicate the emotion and need. The method and apparatus facilitate communicable association between emotions and needs, emotional self-awareness, and self control, through the use of multiple physical, or virtual, blocks having multiple faces suggesting emotions and needs. The invention is useful for promoting the effective identification and communication of emotions and needs, and therefore the mental and emotional well being of humans.

We claim:

1. An educational method to improve an individual's ability to identify and express their emotions and needs, and the relationship between the same, the method comprising the following steps:
a. providing a first set of one or more blocks having labeled faces, each of said faces bearing informative indicia identifying one of a variety of emotions;
b. providing a second set of one or more blocks having labeled faces, each of said faces bearing informative indicia identifying one of a variety of needs;
c. selecting one or more labeled faces from the blocks of the first set, where said selection is made by identifying which of the labeled faces represents a feeling or emotion that best describes the individual;
d. placing the selected block or blocks from the first set on a surface, with the selected face or faces visible;
e. selecting one or more labeled faces from blocks of the second set, where said selection is made by identifying which of the labeled faces represents a need that best describes what would help the individual when the individual feels the emotion identified in the labeled faces from block or blocks selected from the first set; and
f. placing the selected block or blocks from the second set visually adjacent to the block or blocks from the first set, with the selected face or faces visible.

2. The educational method of claim 1, wherein the blocks are cubic.

3. The educational method of claim 1, wherein both the first and second set of blocks further comprises three blocks in each set.

4. The educational method of claim 1, wherein both the first and second set of blocks further comprises two blocks in each set.

5. The educational method of claim 1, wherein both the first and second set of blocks further comprises one block in each set.

6. The educational method of claim 1, wherein the first set of blocks is colored with a first color and second set of blocks is colored with a second color.

7. An educational method to improve an individual's ability to identify and express their emotions and needs, and the relationship between the same, the method comprising the following steps:
a. providing a first set of one or more blocks having labeled faces, each of said faces bearing informative indicia identifying one of a variety of emotions;
b. providing a second set of one or more blocks having labeled faces, each of said faces bearing informative indicia identifying one of a variety of needs;
c. selecting one or more labeled faces from the blocks of the first set, where said selection is made by identifying which of the labeled faces represents an emotion that best describes the individual;
d. placing the selected block or blocks from the first set on a surface, with the selected face or faces visible;
e. selecting one or more labeled faces from blocks of the second set, where said selection is made by identifying which of the labeled faces represents a need that best describes what would help the individual when the individual feels the emotion identified in the labeled faces from block or blocks selected from the first set;
f. placing the selected block or blocks from the second set visually adjacent to the block or blocks from the first set, with the selected face or faces visible; and
g. identifying an association between the individual's emotion represented in the first set of blocks and their need represented in the second set of blocks.

8. The educational method of claim 7, wherein the method additionally comprises expressing an association between the individual's emotion represented in the first set of blocks and the need represented in the second set of blocks.

9. The educational method of claim 7, wherein the method additionally comprises communicating an association between the individual's emotion represented in the first set of blocks and their needs represented in the second set of blocks;

10. The educational method of claim 7, wherein the method additionally comprises formulating an action plan to satisfy the need represented in the second set of blocks.

11. The educational method of claim 7, wherein the method additionally comprises using a support structure for the surface.

12. The educational method of claim 11, wherein the support structure further comprising words and/or images adapted for aiding identification of associations between blocks placed in said recesses.

13. The educational method of claim 11, wherein the support structure further comprises a feeling gauge adapted to aid the individual in identifying the intensity of his or her feelings or needs.

14. The educational method of claim 13, herein the feeling gauge is a numerically graduated scale, as for example between zero and five, with a legend indicating that a level of zero corresponds to “not at all” and a level of five corresponds to a level of “very much.”

15. The educational method of claim 7, wherein the method additionally comprises expressing the intensity with which a particular feeling or need, once identified, is felt by the individual.

16. The educational method of claim 7, wherein the method further comprises
a. providing a third set of one or more blocks having a labeled face, each of said faces bearing an informative indicia of a feeling gauge adapted to aid the individual in identifying the intensity of his or her feelings or needs, where each face represents a graduation in intensity between zero and the number of faces on the block;
b. selecting one face from a block of the third set that represents the intensity of a feeling selected from either the first set of blocks or a need selected from the second set of blocks; and
c. placing the selected block from the third set on the support surface visually adjacent to the block selected from the first or second set, with the selected face visible.

17. The educational method of claim 7, wherein the blocks are cubic.

18. The educational method of claim 7, wherein both the first and second set of blocks further comprises three blocks in each set.

19. The educational method of claim 7, wherein both the first and second set of blocks further comprises two blocks in each set.

20. The educational method of claim 7, wherein both the first and second set of blocks further comprises one block in each set.

21. The educational method of claim 7, wherein the first set of blocks is colored with a first color and second set of blocks is colored with a second color.

22. An educational method to improve an individual's ability to identify and express their emotions and needs, and the relationship between the same, the method comprising the following steps:
a. providing a first set of one or more cubic blocks colored with a first color and having labeled faces, each of said faces bearing informative indicia identifying one of a variety of emotions;
b. providing a second set of one or more cubic blocks colored with a second color and having labeled faces, each of said faces bearing informative indicia identifying one of a variety of needs;
c. providing a support structure;
d. selecting one or more labeled faces from the blocks of the first set, where said selection is made by identifying which of the labeled faces represents an emotion that best describes the individual;
e. removably mounting the selected block or blocks from the first set in the support structure, with the selected face or faces visible;
f. selecting one or more labeled faces from blocks of the second set, where said selection is made by identifying which of the labeled faces represents a need that best describes what would help the individual when the individual feels the emotion identified in the labeled faces from block or blocks selected from the first set;
g. removably mounting the selected block or blocks from the second set in the support structure with the selected face or faces visible, and visually adjacent to the block or blocks from the first set;
h. identifying an association between the individual's emotion represented in the first set of blocks and their need represented in the second set of blocks;
i. expressing the association between the individual's emotion represented in the first set of blocks and the need represented in the second set of blocks;
j. communicating the association between the individual's emotion represented in the first set of blocks and their needs represented in the second set of blocks; and
j. formulating an action plan to satisfy the need represented in the second set of blocks.

23. The educational method of claim 22, wherein the support structure further comprising words and/or images adapted for aiding identification of associations between blocks placed in said recesses.

24. The educational method of claim 22, wherein the support structure further comprises a feeling gauge adapted to aid the individual in identifying the intensity of his or her feelings or needs.

25. The educational method of claim 24, wherein the feeling gauge is a numerically graduated scale, as for example between zero and five, with a legend indicating that a level of zero corresponds to “not at all” and a level of five corresponds to a level of “very much.”

26. The educational method of claim 22, wherein the method additionally comprises expressing the intensity with which a particular feeling or need, once identified, is felt by the individual.

25. The educational method of claim 22, wherein the method further comprises
a. providing a third set of one or more blocks having a labeled face, each of said faces bearing an informative indicia of a feeling gauge adapted to aid the individual in identifying the intensity of his or her feelings or needs, where each face represents a graduation in intensity between zero and the number of faces on the block;
b. selecting one face from a block of the third set that represents the intensity of either a feeling selected from the first set of blocks or a need selected from the second set of blocks;
c. placing the selected block from the third set on the support surface visually adjacent to the block selected from the first or second set, with the selected face visible; and
d. expressing the intensity with which a particular feeling or need, once identified, is felt by the individual.

26. The educational method of claim 22, wherein the method additionally comprises providing the Instructions of the Invention.

27. The educational method of claim 22, wherein both the first and second set of blocks further comprises three blocks in each set.

28. The educational method of claim 22, wherein both the first and second set of blocks further comprises two blocks in each set.

29. The educational method of claim 22, wherein both the first and second set of blocks further comprises one block in each set.

30. An educational apparatus to improve an individual's ability to identify and express their emotions and needs, and the relationship between the same, said apparatus comprising:
a. one or more sets of one or more blocks;
b. each of said blocks having a plurality of labeled faces, each of said labeled faces bearing informative indicia;
c. a surface suitable for supporting a plurality of blocks and forming a cooperative array;
d. the visible informative indicia on each block supported on the surface comprises an element in a cooperative array; and
e. said visible informative indicia on a plurality of blocks supported on the surface form a cooperative array defining an association by the individual, where, by the placement of the blocks on the surface, the individual has identified the informative indicia as representative of them, associated the several informative indicia, and expressed and communicated the same by the cooperative array.

31. The apparatus of claim 30, wherein the apparatus additionally comprises a first set of the plurality of blocks having labeled faces, each of said faces bearing informative indicia identifying one of a variety of emotions; and a second set of the plurality of blocks having labeled faces, each of said faces bearing informative indicia identifying one of a variety of needs.

32. The apparatus of claim 30, wherein the apparatus additionally comprises the Instructions of the Invention.

33. The apparatus of claim 30, wherein the blocks are cubic.

34. The apparatus of claim 30, wherein both the first and second set of blocks further comprises three blocks in each set.

35. The apparatus of claim 30, wherein both the first and second set of blocks further comprises two blocks in each set.

36. The apparatus of claim 30, wherein both the first and second set of blocks further comprises one block in each set.

37. The apparatus of claim 30, wherein the first set of blocks is colored with a first color and second set of blocks is colored with a second color.

38. An educational apparatus to improve an individual's ability to identify and express their emotions and needs, and the relationship between the same, said apparatus comprising:
a. a first set of one or more blocks having labeled faces, each of said faces bearing informative indicia identifying one of a variety of emotions;
b. a second set of one or more blocks having labeled faces, each of said faces bearing informative indicia identifying one of a variety of needs;
c. a support structure;
d. the display area of the support structure comprising a plurality of at least partially segregated areas; each of the plurality of at least partially segregated areas being dimensioned and configured to removably support at least one of the plurality of blocks;
e. each of the plurality of at least partially segregated areas being collectively arranged to support at least one of the plurality of blocks in a cooperative array;
f. a first set of the plurality of said at least partially segregated areas further comprising words and/or images adapted for designating that said first set is for blocks whose labeled faces bear informative indicia identifying one of a variety of emotions;
g. a second set of the plurality of said at least partially segregated areas further comprising words and/or images adapted for designating that said second set is for blocks whose labeled faces bear informative indicia identifying one of a variety of needs;
h. the visible informative indicia on each block supported in said first set of said at least partially segregated area comprises an element in a cooperative array, wherein said visible informative indicia represent an emotion that best describes the individual;
i. the visible informative indicia on each block supported in said second set of said at least partially segregated area comprises an element in the cooperative array, wherein said visible informative indicia represent a need that best describes what would help the individual when the individual feels the emotion identified in the labeled faces from block or blocks in the first set of said at least partially segregated area; and
j. said visible informative indicia on each block supported in two or more at least partially segregated areas comprises a cooperative array defining an association by the individual, where by the placement of the blocks in the support structure, the individual has identified the informative indicia as representative of them, associated the informative indicia, and expressed and communicated the same by the cooperative array.

39. The apparatus of claim 38, wherein the support structure further comprising textual material, pictorial representations, and/or images adapted for aiding identification of associations between blocks placed in two or more at least partially segregated areas of said support structure.

40. The apparatus of claim 38, wherein the support structure further comprises a feeling gauge adapted to aid the individual in identifying the intensity of his or her feelings or needs.

41. The apparatus of claim 40, wherein the feeling gauge is a numerically graduated scale, as for example between zero and five, with a legend indicating that a level of zero corresponds to “not at all” and a level of five corresponds to a level of “very much,” wherein, the individual can identify the intensity with which an identified feeling or need is felt.

42. The apparatus of claim 38, wherein the apparatus further comprises
a. a third set of one or more blocks having a labeled face, each of said faces bearing an informative indicia of a feeling gauge adapted to aid the individual in identifying the intensity of his or her feelings or needs, where each face represents a graduation in intensity between zero and the number of faces on the block; and
b. the visible informative indicia on each block of the third set supported in said set of at least partially segregated area visually adjacent to a block selected from either the first set of blocks or a need comprises an element in the cooperative array, where, by the placement of the block from the third set in the support structure, the individual has identified the informative indicia of said block from the third set as representative of the intensity of their visually adjacent visible informative indicia of a feeling or need, associated the informative indicia, and expressed the same by the cooperative array.

43. The apparatus of claim 38, wherein the apparatus additionally comprises the Instructions of the Invention.

44. The apparatus of claim 38, wherein the blocks are cubic.

45. The apparatus of claim 38, wherein both the first and second set of blocks further comprises two blocks in each set.

46. The apparatus of claim 38, wherein both the first and second set of blocks further comprises one block in each set.

47. The apparatus of claim 38, wherein the first set of blocks is colored with a first color and second set of blocks is colored with a second color.

48. An educational apparatus to improve an individual's ability to identify and express their emotions and needs, and the relationship between the same, said apparatus comprising:
a. a first set of one or more cubic blocks colored with a first color and having labeled faces, each of said faces bearing informative indicia identifying one of a variety of emotions;
b. a second set of one or more cubic blocks colored with a second color and having labeled faces, each of said faces bearing informative indicia identifying one of a variety of needs;
c. a support structure;
d. the display area of the support structure comprising a plurality of at least partially segregated areas; each of the plurality of at least partially segregated areas being dimensioned and configured to removably support at least one of the plurality of blocks;
e. each of the plurality of at least partially segregated areas being collectively arranged to support at least one of the plurality of blocks in a cooperative array;
f. a first set of the plurality of said at least partially segregated areas further comprising words and/or images adapted for designating that said first set is for blocks whose labeled faces bear informative indicia identifying one of a variety of emotions;
g. a second set of the plurality of said at least partially segregated areas further comprising words and/or images adapted for designating that said second set is for blocks whose labeled faces bear informative indicia identifying one of a variety of needs;
h. the visible informative indicia on each block supported in said first set of said at least partially segregated area comprises an element in a cooperative array, wherein said visible informative indicia represent an emotion that best describes the individual;
i. the visible informative indicia on each block supported in said second set of said at least partially segregated area comprises an element in the cooperative array, wherein said visible informative indicia represent a need that best describes what would help the individual when the individual feels the emotion identified in the labeled faces from block or blocks in the first set of said at least partially segregated area; and
j. said visible informative indicia on each block supported in two or more at least partially segregated areas comprises a cooperative array defining an association by the individual, where by the placement of the blocks in the support structure, the individual has identified the informative indicia as representative of them, associated the informative indicia, and expressed and communicated the same by the cooperative array.

49. The apparatus of claim 48, wherein the support structure further comprising textual material, pictorial representations, and/or images adapted for aiding identification of associations between blocks placed in two or more at least partially segregated areas of said support structure.

50. The apparatus of claim 48, wherein the support structure further comprises a feeling gauge adapted to aid the individual in identifying the intensity of his or her feelings or needs, wherein the feeling gauge is a numerically graduated scale, as for example between zero and five, with a legend indicating that a level of zero corresponds to “not at all” and a level of five corresponds to a level of “very much,” wherein, the individual can identify the intensity with which an identified feeling or need is felt.

51. The apparatus of claim 48, wherein the apparatus further comprises;
a. a third set of one or more blocks having a labeled face, each of said faces bearing an informative indicia of a feeling gauge adapted to aid the individual in identifying the intensity of his or her feelings or needs, where each face represents a graduation in intensity between zero and the number of faces on the block; and
b. the visible informative indicia on each block of the third set supported in said set of at least partially segregated area visually adjacent to a block selected from either the first set of blocks or a need comprises an element in the cooperative array, where, by said placement of the block from the third set in the support structure, the individual has identified the informative indicia of said block from the third set as representative of the intensity of the visually adjacent visible informative indicia of a feeling or need, associated the informative indicia, and expressed the same by the cooperative array.

52. The apparatus of claim 48, wherein the apparatus additionally comprises the Instructions of the Invention.

53. The apparatus of claim 48, wherein both the first and second set of blocks further comprises two blocks in each set.

54. The apparatus of claim 48, wherein both the first and second set of blocks further comprises one block in each set.
